(19) United States
(12) Patent Application Publication
(10) Pub. No.: US 2026/0351138 A1
(43) Pub. Date: Nov. 5, 2026

(54) TRAINING APPARATUS FOR OPHTHALMIC SURGERY

(71) Applicant: ForSight Robotics Ltd., Caesarea (IL)

(72) Inventors: Mahdee ZOABI, Ed Dahi (IL); Tal KORMAN, Tel Aviv (IL); Yoav GOLAN, Tel-Aviv (IL); Ori BEN ZEEV, Ramat Hasharon (IL); Yaron LEVINSON, Tel Aviv (IL)

(21) Appl. No.: 19/711,195

(22) Filed: Jun. 17, 2026

Related U.S. Application Data
(63) Continuation-in-part of application No. PCT/IB2024/062678, filed on Dec. 15, 2024.
(60) Provisional application No. 63/611,172, filed on Dec. 17, 2023.

(51) Int. Cl. G09B 23/34; G09B 23/32

(52) U.S. Cl. CPC G09B 23/34; G09B 23/32

(57) ABSTRACT

Apparatus and methods are described including a base, configured for insertion into a prosthetic face. An eye support is configured to hold an imitation human eye. A rotational mechanism is coupled to the base and includes one or more motors configured to rotate the imitation human eye about different respective rotational axes while the imitation human eye is positioned within an eye socket of the prosthetic face. A compression spring is configured to compress when an external force is applied to the imitation human eye to inhibit the imitation human eye from rotating, such that a force generated by the motors is detected, via the spring, by an applier of the external force. Other applications are also described.

### CROSS-REFERENCE TO RELATED APPLICATIONS

The present application is a continuation-in-part of PCT application PCT/IB2024/062678 to Zoabi et al. (published as WO 25/133866), entitled “Training apparatus for ophthalmic surgery,” filed Dec. 15, 2024, which claims priority from U.S. Provisional Application 63/611,172 to Zoabi et al., entitled “Training apparatus for ophthalmic surgery,” filed Dec. 17, 2023, which is incorporated herein by reference.

### FIELD OF EMBODIMENTS

The present disclosure is related to the field of ophthalmic surgery, and in particular to training apparatus for ophthalmic surgery.

### BACKGROUND

Cataract surgery involves the removal of the natural lens of the eye that has developed an opacification (known as a cataract), and its replacement with an intraocular lens. Such surgery typically involves a number of standard steps, which are performed sequentially.

In an initial step, the patient's face around the eye is disinfected (typically, with iodine solution), and the face is covered by a sterile drape, such that only the eye is exposed. When the disinfection and draping has been completed, the eye is anesthetized, typically using a local anesthetic, which is administered in the form of liquid eye drops. The eyeball is then exposed, using an eyelid speculum that holds the upper and lower eyelids open. One or more incisions (and typically two or three incisions) are made in the cornea of the eye. The incision(s) are typically made using a specialized blade, which is called a keratome blade. At this stage, lidocaine is typically injected into the anterior chamber of the eye, in order to further anesthetize the eye. Following this step, a viscoelastic injection is applied via the corneal incision(s). The viscoelastic injection is performed in order to stabilize the anterior chamber and to help maintain eye pressure during the remainder of the procedure, and also in order to distend the lens capsule.

In a subsequent stage, known as capsulorhexis, a part of the anterior lens capsule is removed. Various enhanced techniques have been developed for performing capsulorhexis, such as laser-assisted capsulorhexis, zepto-rhexis (which utilizes precision nano-pulse technology), and marker-assisted capsulorhexis (in which the cornea is marked using a predefined marker, in order to indicate the desired size for the capsule opening).

Subsequently, it is common for a fluid wave to be injected via the corneal incision, in order to dissect the cataract's outer cortical layer, in a step known as hydrodissection. In a subsequent step, known as hydrodelineation, the outer softer epi-nucleus of the lens is separated from the inner firmer endo-nucleus by the injection of a fluid wave. In the next step, ultrasonic emulsification of the lens is performed, in a process known as phacoemulsification. The nucleus of the lens is broken initially using a chopper, following which the outer fragments of the lens are broken and removed, typically using an ultrasonic phacoemulsification probe. Further typically, a separate tool is used to perform suction during the phacoemulsification. When the phacoemulsification is complete, the remaining lens cortex (i.e., the outer layer of the lens) material is aspirated from the capsule. During the phacoemulsification and the aspiration, aspirated fluids are typically replaced with irrigation of a balanced salt solution, in order to maintain fluid pressure in the anterior chamber. In some cases, if deemed to be necessary, the capsule is polished. Subsequently, the intraocular lens (IOL) is inserted into the capsule. The IOL is typically foldable and is inserted in a folded configuration, before unfolding inside the capsule. At this stage, the viscoelastic is removed, typically using the suction device that was previously used to aspirate fluids from the capsule. If necessary, the incision(s) is sealed by elevating the pressure inside the bulbus oculi (i.e., the globe of the eye), causing the internal tissue to be pressed against the external tissue of the incision, such as to force closed the incision.

In some types of robotic surgery, one or more robotic arms, which are mounted to a chassis, manipulate respective surgical tools under the control of an operator.

### SUMMARY

Embodiments of the present disclosure provide a training apparatus for manual or robotic ophthalmic surgery, such as cataract surgery. The apparatus is configured to hold an imitation human eye, and is insertable into a prosthetic face such that the imitation human eye is positioned within an eye socket of the prosthetic face. The apparatus is further configured to rotate the imitation human eye about multiple rotational axes, such as a pitch and yaw axis, while the imitation human eye is positioned within the eye socket. During a training procedure, a user performs a simulated surgery (manually or via a robotic arm) on the imitation human eye while the apparatus provides a realistic simulation of ocular movement.

Typically, the apparatus includes a base, which is configured for insertion into the prosthetic face, an eye support, which is configured to hold the imitation human eye, and a rotational mechanism coupled to the base. The rotational mechanism includes one or more motors configured to rotate the imitation human eye about different respective rotational axes while the imitation human eye is positioned within the eye socket of the prosthetic face. For example, the rotational mechanism may further include one or more arms, at least one of which is coupled to the eye support, and the motors may be configured to move the arms so as to rotate the imitation human eye.

Typically, the apparatus is configured to oppose an external force applied to the imitation human eye (i.e., a force applied to the imitation human eye from outside the apparatus), thus providing a realistic simulation of ocular muscular force. Thus, for example, to hold the eye in place during the simulated surgery, the user may need to overcome the opposing force. For example, the rotational mechanism may include at least one compression spring configured to compress when an external force is applied to the imitation human eye to inhibit the imitation human eye from rotating, such that the force generated by the motors is detected, via the spring, by the applier of the external force.

Alternatively or additionally, the apparatus allows small translational movements of the imitation human eye, thereby mimicking the slight degree of translational freedom of a real eye.

In addition to training an ophthalmic surgeon, the apparatus described herein may be used to test a robotic surgical system, or even to train the robotic system (e.g., using machine-learning techniques) to perform the surgery automatically, with minimal or no human intervention.

There is therefore provided, in accordance with some applications of the present disclosure, an apparatus for use with a prosthetic face and an imitation human eye, including:
a base, configured for insertion into the prosthetic face;
an eye support, configured to hold the imitation human eye; and
a rotational mechanism coupled to the base and including:
   one or more motors configured to rotate the imitation human eye about different respective rotational axes while the imitation human eye is positioned within an eye socket of the prosthetic face; and
   at least one compression spring configured to compress when an external force is applied to the imitation human eye to inhibit the imitation human eye from rotating, such that a force generated by the motors is detected, via the spring, by an applier of the external force.

In some applications, the base is configured for insertion into the prosthetic face from a side of the prosthetic face.

In some applications, the side is a first side, and the eye socket is at a second side of the prosthetic face opposite the first side.

In some applications, the motors include:
a pitch-axis motor, configured to rotate the imitation human eye about a pitch axis of the imitation human eye; and
a yaw-axis motor, configured to rotate the imitation human eye about a yaw axis of the imitation human eye.

In some applications, the rotational mechanism further includes one or more arms, at least one of which is coupled to the eye support, and the motors are configured to rotate the imitation human eye by moving the arms.

In some applications, the arms are sufficiently flexible so as to allow translational movement of the eye support.

In some applications,
the rotational mechanism further includes:
   a shaft; and
   an axle passing perpendicularly through the shaft and coupled to one of the motors,
and
the one of the motors is configured to rotate the imitation human eye about one of the rotational axes by rotating the axle.

In some applications, the arms include:
one or more first axial arms, which are pivotably coupled to the eye support;
one or more second axial arms, which are pivotably coupled to the eye support at a transverse offset from the first axial arms;
one or more first transverse arms, which are pivotably coupled to the axle and to the first axial arms; and
one or more second transverse arms, which are pivotably coupled to the shaft, to the first axial arms, and to the second axial arms.

In some applications,
the rotational mechanism further includes:
   a spring anchor coupled to the axle; and
   a spring head disposed over the axle adjacently to one of the first transverse arms,
and
the compression spring is coupled between the spring anchor and the spring head, such that the spring head and compression spring oppose rotation of the axle and the first transverse arms with respect to one another.

In some applications,
the spring head includes a sloped surface, and
the rotational mechanism further includes one or more rollers coupled to the one of the first transverse arms and configured to roll along the sloped surface as the axle and the one of the first transverse arms rotate with respect to one another, thereby increasingly compressing the spring.

In some applications,
one of the first transverse arms includes a sloped surface, and
the spring head includes one or more rollers configured to roll along the sloped surface as the axle and the one of the first transverse arms rotate with respect to one another, thereby increasingly compressing the spring.

In some applications,
the rotational mechanism further includes:
   a shaft; and
   an axle coupled to the shaft, and
one of the motors is coupled to the axle and is configured to rotate the imitation human eye about one of the rotational axes by rotating the axle, thereby rotating the shaft.

In some applications,
the rotational mechanism further includes:
   a spring anchor coupled to the axle; and
   a spring head disposed over the axle adjacently to an end of the shaft, and
the compression spring is coupled between the spring anchor and the spring head, such that the spring head and compression spring oppose rotation of the axle and the shaft with respect to one another.

In some applications,
the spring head includes a sloped surface, and
the rotational mechanism further includes one or more rollers coupled to the end of the shaft and configured to roll along the sloped surface as the axle and the shaft rotate with respect to one another, thereby increasingly compressing the spring.

In some applications,
the end of the shaft includes a sloped surface, and
the spring head includes one or more rollers configured to roll along the sloped surface as the axle and the shaft rotate with respect to one another, thereby increasingly compressing the spring.

In some applications, the apparatus further includes a jig configured to apply intermittent movement to the prosthetic face.

In some applications, the jig includes a cam-and-follower mechanism configured to apply intermittent movement to the prosthetic face.

In some applications, the jig is configured to apply intermittent movement to the prosthetic face in a plurality of degrees-of freedom.

There is further provided, in accordance with some applications of the present disclosure, a method, including:
using the apparatus according to any one of claims 1-4, training an automated robotic surgical system.

There is further provided, in accordance with some applications of the present disclosure, an apparatus for use with a prosthetic face and an imitation human eye, including:
a base, configured for insertion into the prosthetic face;
an eye support, configured to hold the imitation human eye; and
a rotational mechanism coupled to the base and including:
   one or more arms, at least one of which is coupled to the eye support; and
   one or more motors configured to move the arms so as to rotate the imitation human
eye about different respective rotational axes while the imitation human eye is positioned within an eye socket of the prosthetic face.

In some applications, the motors include:
a pitch-axis motor, configured to rotate the imitation human eye about a pitch axis of the imitation human eye; and
a yaw-axis motor, configured to rotate the imitation human eye about a yaw axis of the imitation human eye.

In some applications, the base is configured for insertion into the prosthetic face from a side of the prosthetic face.

In some applications, the side is a first side, and the eye socket is at a second side of the prosthetic face opposite the first side.

In some applications, the arms are sufficiently flexible so as to allow translational movement of the eye support.

In some applications, the rotational mechanism is configured to oppose an external force applied to the imitation human eye.

In some applications, the rotational mechanism includes at least one compression spring configured to oppose the external force.

In some applications,
the rotational mechanism further includes:
   a shaft; and
   an axle passing perpendicularly through the shaft and coupled to one of the motors,
and
the one of the motors is configured to rotate the imitation human eye about one of the rotational axes by rotating the axle.

In some applications, the arms include:
one or more first axial arms, which are pivotably coupled to the eye support;
one or more second axial arms, which are pivotably coupled to the eye support at a transverse offset from the first axial arms;
one or more first transverse arms, which are pivotably coupled to the axle and to the first axial arms; and
one or more second transverse arms, which are pivotably coupled to the shaft, to the first axial arms, and to the second axial arms.

In some applications, the rotational mechanism further includes:
a spring anchor coupled to the axle;
a spring head disposed over the axle adjacently to one of the first transverse arms; and
a compression spring coupled between the spring anchor and the spring head,
   the spring head and compression spring being configured to oppose rotation of the axle and the first transverse arms with respect to one another.

In some applications,
the spring head includes a sloped surface, and
the rotational mechanism further includes one or more rollers coupled to the one of the first transverse arms and configured to roll along the sloped surface as the axle and the one of the first transverse arms rotate with respect to one another, thereby increasingly compressing the spring.

In some applications,
one of the first transverse arms includes a sloped surface, and
the spring head includes one or more rollers configured to roll along the sloped surface as the axle and the one of the first transverse arms rotate with respect to one another, thereby increasingly compressing the spring.

In some applications,
the rotational mechanism further includes:
   a shaft; and
   an axle coupled to the shaft, and
one of the motors is coupled to the axle and is configured to rotate the imitation human eye about one of the rotational axes by rotating the axle, thereby rotating the shaft.

In some applications,
the rotational mechanism further includes:
   a spring anchor coupled to the axle;
   a spring head disposed over the axle adjacently to an end of the shaft; and
   a compression spring coupled between the spring anchor and the spring head,
      the spring head and compression spring being configured to oppose rotation of the axle and the shaft with respect to one another.

In some applications,
the spring head includes a sloped surface, and
the rotational mechanism further includes one or more rollers coupled to the end of the shaft and configured to roll along the sloped surface as the axle and the shaft rotate with respect to one another, thereby increasingly compressing the spring.

In some applications,
the end of the shaft includes a sloped surface, and
the spring head includes one or more rollers configured to roll along the sloped surface as the axle and the shaft rotate with respect to one another, thereby increasingly compressing the spring.

In some applications, the apparatus further includes a jig configured to apply intermittent movement to the prosthetic face.

In some applications, the jig includes a cam-and-follower mechanism configured to apply intermittent movement to the prosthetic face.

In some applications, the jig is configured to apply intermittent movement to the prosthetic face in a plurality of degrees-of freedom.

There is further provided, in accordance with some applications of the present disclosure, a method, including:
using the apparatus according to any one of claims 16-20, training an automated robotic surgical system.

The present disclosure will be more fully understood from the following detailed description of embodiments thereof, taken together with the drawings, in which:

### BRIEF DESCRIPTION OF THE DRAWINGS

FIG. 1 is a schematic illustration of a training apparatus in use with a prosthetic face, in accordance with some embodiments of the present disclosure;

FIG. 2 is a schematic illustration of the training apparatus shown in FIG. 1, in accordance with some embodiments of the present disclosure;

FIG. 3 is a schematic illustration of a rotational mechanism, in accordance with some embodiments of the present disclosure;

FIGS. 4A and 4B show a training apparatus in different phases of a rotation around a pitch axis, in accordance with some embodiments of the present disclosure;

FIGS. 5A and 5B show a training apparatus in different phases of a rotation around a yaw axis, in accordance with some embodiments of the present disclosure;

FIG. 6 is a schematic illustration of a portion of a rotational mechanism, in accordance with some embodiments of the present disclosure; and

FIG. 7 of a schematic illustration of a which is a schematic illustration of a jig configured to apply intermittent motion to a prosthetic face within which an imitation human eye is disposed, in accordance with some applications of the present disclosure.

### DETAILED DESCRIPTION

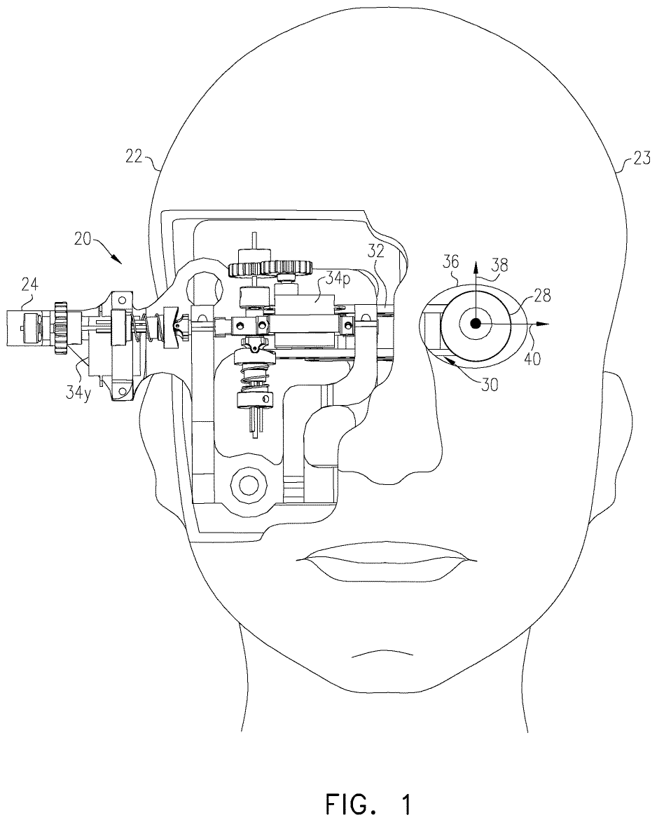

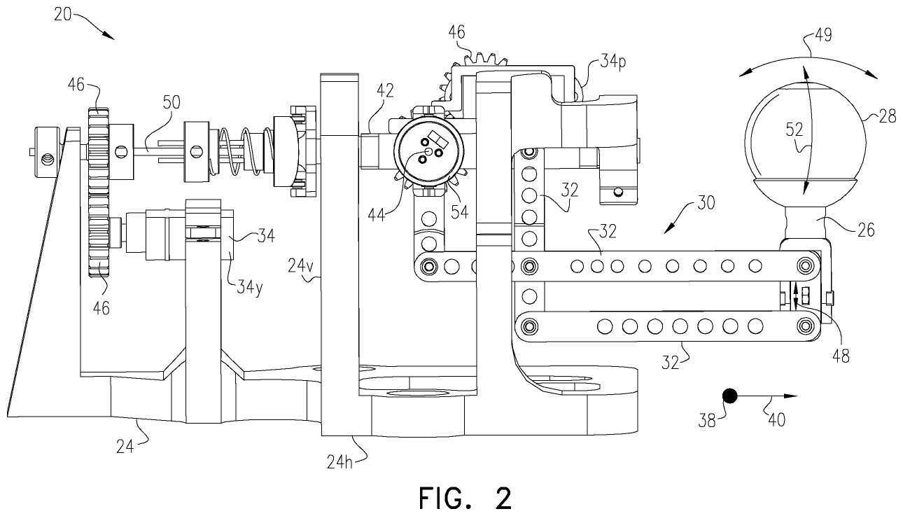

Reference is initially made to FIG. 1, which is a schematic illustration of a training apparatus 20 in use with a prosthetic face 22, in accordance with some embodiments of the present disclosure. Reference is also made to FIG. 2, which is a schematic illustration of training apparatus 20, in accordance with some embodiments of the present disclosure.

As described hereinabove, embodiments of the present disclosure provide training apparatus 20 for manual or robotic ophthalmic surgery, such as cataract surgery. The apparatus is configured to hold an imitation human eye 28, and is insertable into a prosthetic face 22, which in turn belongs to a prosthetic head 23, such that the imitation human eye is positioned within an eye socket of the prosthetic face. The apparatus is further configured to rotate the imitation human eye about multiple rotational axes, such as a pitch and yaw axis, while the imitation human eye is positioned within the eye socket. During a training procedure, a user performs a simulated surgery (manually or via a robotic arm) on the imitation human eye while the apparatus provides a realistic simulation of ocular movement.

Apparatus 20 comprises a base 24 configured for insertion into prosthetic face 22 such that at least part of base 24 is disposed within the prosthetic face. Base 24 typically comprises a horizontal portion 24h, which is configured to rest on a horizontal surface while apparatus 20 is used, and one or more vertical portions 24v, which are coupled to, or are continuous with, horizontal portion 24h, and are configured to support the other components of apparatus 20 described below.

Apparatus 20 further comprises an eye support 26 configured to hold imitation human eye 28, such as a prosthetic or porcine eye, and a rotational mechanism 30 coupled to base 24 (typically, to vertical portions 24v). Mechanism 30 comprises one or more arms 32, at least one of which is coupled to eye support 26, and one or more motors 34.

Base 24 is inserted into prosthetic face 22 until imitation human eye 28 is positioned within an eye socket 36 of the prosthetic face. Typically, as depicted in FIG. 1, base 24 is inserted into prosthetic face 22 from a side of the prosthetic face, e.g., such that apparatus 20 extends mainly along the lateral axis of the prosthetic face. Typically, the base is inserted from the side of the prosthetic face that is opposite the side of eye socket 36, such that apparatus 20 protrudes less from the prosthetic face, relative to if the insertion were from the side of eye socket 36. Advantageously, insertion of the base from the side is typically more convenient, relative to other insertion directions.

Motors 34 are configured to move arms 32 so as to rotate imitation human eye 28 about different respective rotational axes while the imitation human eye is positioned within eye socket 36. Typically, motors 34 comprise a pitch-axis motor 34p, configured to rotate the imitation human eye about the pitch axis 38 of the imitation human eye, and a yaw-axis motor 34y, configured to rotate the imitation human eye about the yaw axis 40 of the imitation human eye. (It is noted that the designation of the pitch and yaw axes, as shown in FIGS. 1-2, is arbitrary, and per an alternate convention, the pitch and yaw axes are interchanged.)

Typically, apparatus 20 further comprises wires configured to connect motors 34 to control circuitry configured to rotate the imitation human eye during a training procedure. Thus, for example, a user may practice holding the eye in place and operating on the eye (manually or via a robotic arm) while the eye “tries” to move. Alternatively, for example, an automated robotic surgical system may be trained to hold the eye in place and operate on the eye while the eye tries to move.

In some embodiments, the control circuitry is connected (e.g., via a universal serial bus (USB) cable) to a computer, such as a laptop or desktop computer, configured to instruct the control circuitry. For example, the computer may instruct the control circuitry to rotate the imitation human eye in accordance with a predefined sequence of movements and/or in accordance with user input. Alternatively or additionally, the control circuitry is connected to a separate input interface, such as a joystick, and a user rotates the imitation human eye via the input interface and control circuitry. Power may be supplied to the motors via the aforementioned computer or via a separate power supply.

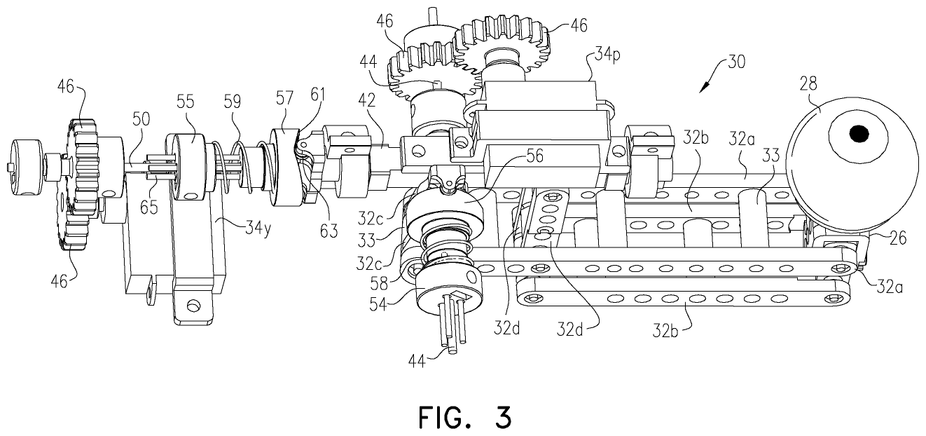

For further details regarding the rotation of imitation human eye 28, reference is now additionally made to FIG. 3, which is a schematic illustration of rotational mechanism 30, in accordance with some embodiments of the present disclosure. (FIG. 3 differs from FIG. 2 by virtue of showing a different perspective, with base 24 hidden from view.)

Typically, rotational mechanism 30 further comprises a shaft 42. An axle 44 passes perpendicularly through shaft 42 and is coupled to one of motors 34, optionally via gears 46.

Arms 32 comprise one or more first axial arms 32a, which are pivotably coupled to eye support 26, and one or more second axial arms 32b, which are pivotably coupled to eye support 26 at a transverse offset 48 (FIG. 2) from first axial arms 32a. For example, arms 32 may comprise two first axial arms 32a, which are coupled to opposite sides of the eye support, and two second axial arms 32b, which are also coupled to opposite sides of the eye support, with optional stabilizing rods 33 coupling the first axial arms to one another and the second axial arms to one another. (First axial arms 32a and second axial arms 32b are referred to as “axial” because these arms, in some embodiments, extend along the main axis of the apparatus, and offset 48 is referred to “transverse” by virtue of being oriented transversely to these arms.)

Arms 32 further comprise one or more first transverse arms 32c, which are pivotably coupled to axle 44 and to first axial arms 32a. (Transverse arms 32c are referred to as “transverse” by virtue of having an approximately transverse orientation, relative to the axial arms.) For example, arms 32 may comprise two first transverse arms 32c coupled to the axle at opposite sides of shaft 42, each of the first transverse arms being coupled to a respective one of the first axial arms, with one or more optional stabilizing rods 33 coupling the first transverse arms to one another. Arms 32 further comprise one or more second transverse arms 32d, which are pivotably coupled to shaft 42, to first axial arms 32a, and to second axial arms 32b. For example, arms 32 may comprise two second transverse arms 32d coupled to opposite sides of the shaft, each of the second transverse arms being coupled to a respective one of the first axial arms and a respective one of the second axial arms, with one or more optional stabilizing rods 33 coupling the second transverse arms to one another.

The motor coupled to axle 44 is configured to rotate imitation human eye 28 about one of the rotational axes by rotating the axle.

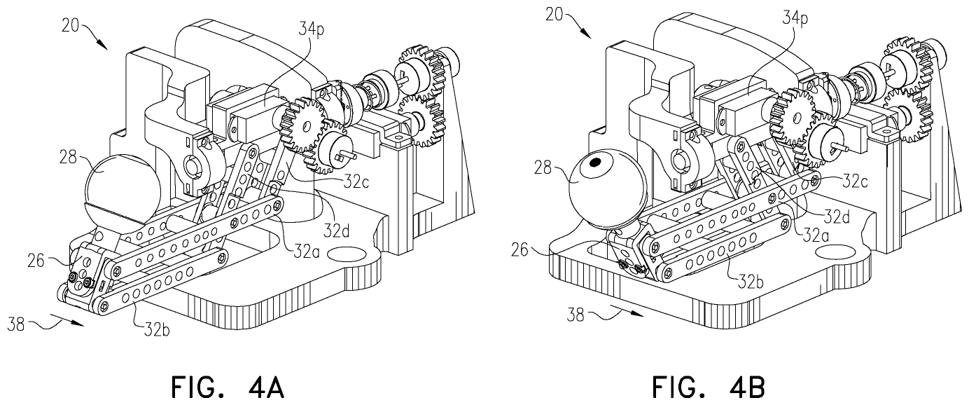

For example, for the embodiment shown in the present figures, motor 34p is configured to rotate the imitation human eye about pitch axis 38, as indicated in FIG. 2 by a rotation indicator 49. FIGS. 4A-4B show apparatus 20 in different phases of this rotation.

Referring again to FIGS. 2-3, typically, rotational mechanism 30 further comprises another axle 50 coupled to shaft 42. Another one of motors 34 is coupled to axle 50, optionally via gears 46, and is configured to rotate imitation human eye 28 about another rotational axis by rotating axle 50, thereby rotating shaft 42.

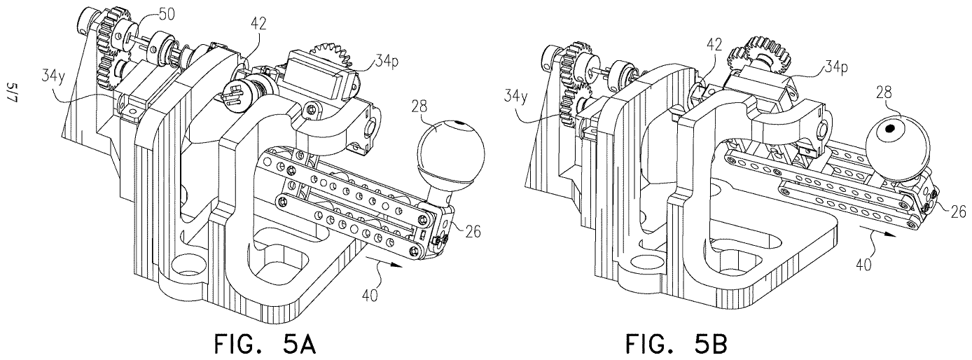

For example, for the embodiment shown in the present figures, motor 34y is configured to rotate the imitation human eye about yaw axis 40, as indicated in FIG. 2 by a rotation indicator 52. FIGS. 5A-5B show apparatus 20 in different phases of this rotation.

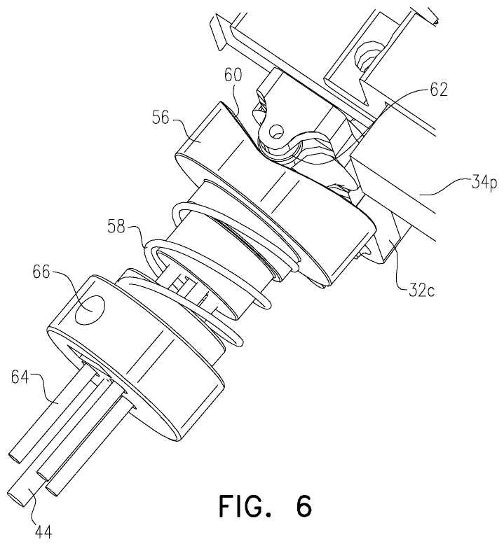

Reference is again made to FIG. 3, and also to FIG. 6, which is a schematic illustration of a portion of rotational mechanism 30, in accordance with some embodiments of the present disclosure.

In some embodiments, rotational mechanism 30 further comprises a spring anchor 54 coupled to axle 44 (e.g., via a screw 66), a spring head 56 disposed over the axle adjacently to one of first transverse arms 32c, and a compression spring 58 coupled between spring anchor 54 and spring head 56. Spring head 56 and compression spring 58 are configured to oppose rotation of the axle and the first transverse arms with respect to one another.

Thus, as the axle rotates while the imitation human eye is held still, or is rotated with respect to the axle, by a user or by a robotic arm, spring head 56 and compression spring 58 provide an opposing force that is detected by the user or robotic arm. This opposing force, which is a function of the (adjustable) position of spring anchor 54 and the spring constant of spring 58, mimics the resistance of the ocular muscles. On the other hand, as the axle rotates while the imitation human eye is allowed to rotate (i.e., is not held still), first transverse arms 32c and spring head 56 rotate with the axle, as shown in FIGS. 4A-4B for example.

Typically, at least one of first transverse arms 32c is coupled to axle 44 via a bearing. While the imitation human eye is allowed to rotate, the bearing transfers rotational force from the axle to the first transverse arms 32c, such that the first transverse arms rotate with the axle. On the other hand, while the imitation human eye is held still during rotation of the axle, or while the imitation human eye is rotated with respect to the axle, the bearing allows rotation of the first transverse arms and the axle with respect to one another.

In some embodiments, spring head 56 comprises a sloped surface 60, and the rotational mechanism further comprises one or more (e.g., two) rollers 62 coupled to the adjacent first transverse arm 32c. Alternatively, spring head 56 comprises rollers 62, and the adjacent first transverse arm 32c comprises sloped surface 60. Rollers 62 are configured to roll along sloped surface 60 as axle 44 and the first transverse arm rotate with respect to one another, thereby increasingly compressing spring 58. Thus, while the user or robotic arm holds or rotates the imitation human eye, the user or robotic arm feels an increasing opposing force that mimics the increasing resistance of the ocular muscles.

In some embodiments, spring anchor 54 and spring head 56 are disposed over one or more rods 64, which help stabilize the spring head by inhibiting rotation of the spring head.

Alternatively or additionally, a similar mechanism for mimicking muscular resistance is provided for another rotational axis. For example, FIG. 3 shows another spring anchor 55 coupled to axle 50, another spring head 57 disposed over axle 50 adjacently to the end of shaft 42, and another compression spring 59 coupled between spring anchor 55 and spring head 57. Spring head 57 and compression spring 59 are configured to oppose rotation of axle 50 and shaft 42 with respect to one another. Thus, as axle 50 rotates while the imitation human eye is held still, or while the imitation human eye is rotated with respect to axle 50, spring head 57 and compression spring 59 provide an opposing force that is detected by the user or robotic arm.

Typically, shaft 42 is coupled to axle 50 via a bearing. While the imitation human eye is allowed to rotate, the bearing transfers rotational force from the axle to the shaft, such that the shaft rotates with the axle. On the other hand, while the imitation human eye is held still during rotation of the axle, or while the imitation human eye is rotated with respect to the axle, the bearing allows rotation of the shaft and the axle with respect to one another.

In some embodiments, spring head 57 comprises a sloped surface 61, and rotational mechanism 30 further comprises one or more (e.g., two) rollers 63 coupled to the end of the shaft. Alternatively, spring head 57 comprises rollers 63, and the end of the shaft comprises sloped surface 61. Rollers 63 are configured to roll along sloped surface 61 as the axle and the shaft rotate with respect to one another, thereby increasingly compressing spring 59.

In some embodiments, spring anchor 55 and spring head 57 are disposed over one or more rods 65, which help stabilize the spring head by inhibiting rotation of the spring head.

Typically, arms 32 are sufficiently flexible so as to allow translational movement (typically, a relatively small amount, e.g., less than 1 mm, of translational movement) of eye support 26. This allowance of translational movement mimics the translational freedom of movement of a real human eye.

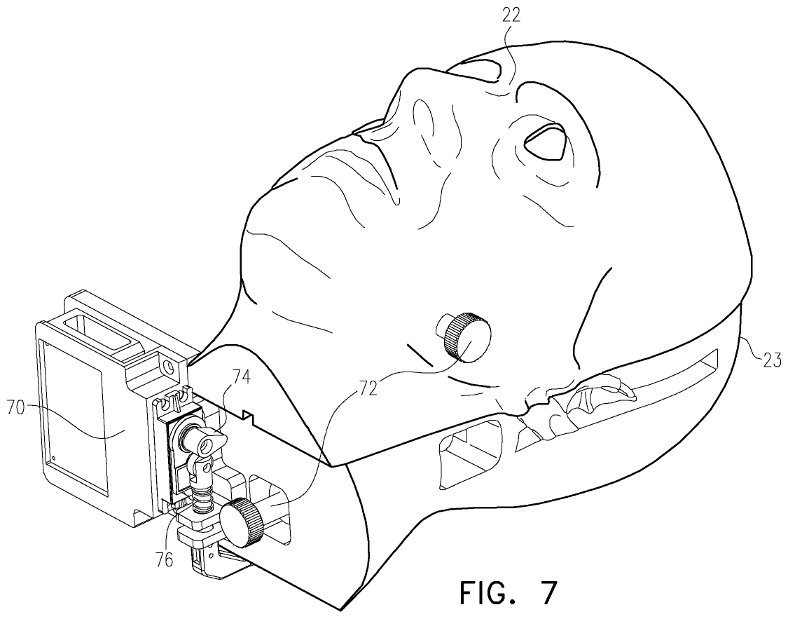

Reference is now made to FIG. 7, which is a schematic illustration of a jig 70 configured to apply intermittent motion to prosthetic face 22 within which imitation human eye 28 is disposed, in accordance with some applications of the present disclosure. It is noted that FIG. 7 shows prosthetic face 22 of prosthetic head 23 in the absence of imitation human eye 28 and training apparatus 20, for illustrative purposes. However, jig 70 is typically used in combination with imitation human eye 28 and training apparatus 20.

As described hereinabove, embodiments of the present disclosure provide a training apparatus for manual or robotic ophthalmic surgery, such as cataract surgery. The apparatus is configured to hold the imitation human eye, and is insertable into prosthetic face 22 such that the imitation human eye is positioned within an eye socket of the prosthetic face. The apparatus is further configured to rotate the imitation human eye about multiple rotational axes, such as a pitch and yaw axis, while the imitation human eye is positioned within the eye socket. During a training procedure, a user performs a simulated surgery (manually or via a robotic arm) on the imitation human eye while the apparatus provides a realistic simulation of ocular movement. For some applications, in order to mimic intermittent movement of a patient's head that can occur during surgery (and to thereby provide training that allows for such movement), the jig 70 applies intermittent motion to the prosthetic face (e.g., by applying intermittent movement to prosthetic head 23).

As shown in FIG. 7, for some applications, the jig is coupled to the prosthetic head, via one or more coupling mechanisms 72, e.g., bolts, screws, adhesive etc. Typically, the jig includes a mechanism for effecting the intermittent motion. For example, the jig may include a cam-and-follower mechanism comprising a cam 74 and a follower 76, or another mechanism, e.g., a motor and linkage assembly. For some applications, the jig includes such mechanisms to effect intermittent motion in two or more degrees of freedom, e.g., to effect rotational motion of the prosthetic face (to correspond to nodding up and down, turning left and right, and/or tilting ear to shoulder), and/or translational motion of the prosthetic face.

Notwithstanding the specific embodiments described above, it is noted that the scope of the present disclosure includes any embodiment in which rotational mechanism 30 is configured to oppose an external force applied to the imitation human eye, such as an external force applied to rotate the imitation human eye or to inhibit the motors from rotating the imitation human eye. For example, the rotational mechanism may comprise at least one compression spring configured to oppose the external force. Thus, for example, as described above, the compression spring may compress when an external force is applied to the imitation human eye to inhibit the imitation human eye from rotating, such that the force generated by the motors is detected, via the spring, by the applier of the external force (i.e., the user or the robotic arm).

It will be appreciated by persons skilled in the art that the present disclosure is not limited to what has been particularly shown and described hereinabove. Rather, the scope of the present disclosure includes both combinations and subcombinations of the various features described hereinabove, as well as variations and modifications thereof that are not in the prior art, which would occur to persons skilled in the art upon reading the foregoing description.

1. An apparatus for use with a prosthetic face and an imitation human eye, the apparatus comprising:
a base, configured for insertion into the prosthetic face;
an eye support, configured to hold the imitation human eye; and
a rotational mechanism coupled to the base and comprising:
one or more motors configured to rotate the imitation human eye about different respective rotational axes while the imitation human eye is positioned within an eye socket of the prosthetic face; and
at least one compression spring configured to compress when an external force is applied to the imitation human eye to inhibit the imitation human eye from rotating, such that a force generated by the motors is detected, via the spring, by an applier of the external force.

2. The apparatus according to claim 1, wherein the base is configured for insertion into the prosthetic face from a side of the prosthetic face.

3. The apparatus according to claim 2, wherein the side is a first side, and wherein the eye socket is at a second side of the prosthetic face opposite the first side.

4. The apparatus according to claim 1, wherein the motors comprise:
a pitch-axis motor, configured to rotate the imitation human eye about a pitch axis of the imitation human eye; and
a yaw-axis motor, configured to rotate the imitation human eye about a yaw axis of the imitation human eye.

5. The apparatus according to claim 1, wherein the rotational mechanism further comprises one or more arms, at least one of which is coupled to the eye support, and wherein the motors are configured to rotate the imitation human eye by moving the arms.

6. The apparatus according to claim 5, wherein the arms are sufficiently flexible so as to allow translational movement of the eye support.

7. The apparatus according to claim 5,
wherein the rotational mechanism further comprises:
a shaft; and
an axle passing perpendicularly through the shaft and coupled to one of the motors, and
wherein the one of the motors is configured to rotate the imitation human eye about one of the rotational axes by rotating the axle.

8. The apparatus according to claim 7, wherein the arms comprise:
one or more first axial arms, which are pivotably coupled to the eye support;
one or more second axial arms, which are pivotably coupled to the eye support at a transverse offset from the first axial arms;
one or more first transverse arms, which are pivotably coupled to the axle and to the first axial arms; and
one or more second transverse arms, which are pivotably coupled to the shaft, to the first axial arms, and to the second axial arms.

9. The apparatus according to claim 8,
wherein the rotational mechanism further comprises:
a spring anchor coupled to the axle; and
a spring head disposed over the axle adjacently to one of the first transverse arms, and
wherein the compression spring is coupled between the spring anchor and the spring head, such that the spring head and compression spring oppose rotation of the axle and the first transverse arms with respect to one another.

10. The apparatus according to claim 9,
wherein the spring head comprises a sloped surface, and
wherein the rotational mechanism further comprises one or more rollers coupled to the one of the first transverse arms and configured to roll along the sloped surface as the axle and the one of the first transverse arms rotate with respect to one another, thereby increasingly compressing the spring.

11. The apparatus according to claim 9,
wherein one of the first transverse arms comprises a sloped surface, and
wherein the spring head comprises one or more rollers configured to roll along the sloped surface as the axle and the one of the first transverse arms rotate with respect to one another, thereby increasingly compressing the spring.

12. The apparatus according to claim 1,
wherein the rotational mechanism further comprises:
a shaft; and
an axle coupled to the shaft, and
wherein one of the motors is coupled to the axle and is configured to rotate the imitation human eye about one of the rotational axes by rotating the axle, thereby rotating the shaft.

13. The apparatus according to claim 12,
wherein the rotational mechanism further comprises:
a spring anchor coupled to the axle; and
a spring head disposed over the axle adjacently to an end of the shaft, and
wherein the compression spring is coupled between the spring anchor and the spring head, such that the spring head and compression spring oppose rotation of the axle and the shaft with respect to one another.

14. The apparatus according to claim 13,
wherein the spring head comprises a sloped surface, and
wherein the rotational mechanism further comprises one or more rollers coupled to the end of the shaft and configured to roll along the sloped surface as the axle and the shaft rotate with respect to one another, thereby increasingly compressing the spring.

15. The apparatus according to claim 13,
wherein the end of the shaft comprises a sloped surface, and
wherein the spring head comprises one or more rollers configured to roll along the sloped surface as the axle and the shaft rotate with respect to one another, thereby increasingly compressing the spring.

16. The apparatus according to claim 1, further comprising a jig configured to apply intermittent movement to the prosthetic face.

17. The apparatus according to claim 16, wherein the jig comprises a cam-and-follower mechanism configured to apply intermittent movement to the prosthetic face.

18. The apparatus according to claim 16, wherein the jig is configured to apply intermittent movement to the prosthetic face in a plurality of degrees-of freedom.

19. A method, comprising:
using the apparatus according to claim 1, training an automated robotic surgical system.

20. An apparatus for use with a prosthetic face and an imitation human eye, the apparatus comprising:
a base, configured for insertion into the prosthetic face;
an eye support, configured to hold the imitation human eye; and
a rotational mechanism coupled to the base and comprising:
one or more arms, at least one of which is coupled to the eye support; and
one or more motors configured to move the arms so as to rotate the imitation human eye about different respective rotational axes while the imitation human eye is positioned within an eye socket of the prosthetic face.

21. The apparatus according to claim 20, wherein the motors comprise:
a pitch-axis motor, configured to rotate the imitation human eye about a pitch axis of the imitation human eye; and
a yaw-axis motor, configured to rotate the imitation human eye about a yaw axis of the imitation human eye.

22. A method, comprising:
using the apparatus according to claim 20, training an automated robotic surgical system.
